(19) United States
(12) Patent Application Publication
(10) Pub. No.: US 2017/0151728 A1
(43) Pub. Date: Jun. 1, 2017

(54) Machine and a Method for Additive Manufacturing with Continuous Fiber Reinforcements

(71) Applicant: UT-Battelle, LLC, Oak Ridge, TN (US)

(72) Inventors: Vlastimil Kunc, Knoxville, TN (US); Craig A. Blue, Knoxville, TN (US); Chad E. Duty, Loudon, TN (US); Randall F. Lind, Loudon, TN (US); John M. Lindahl, Knoxville, TN (US); Peter D. Lloyd, Knoxville, TN (US); Lonnie J. Love, Knoxville, TN (US); Matthew R. Love, Knoxville, TN (US); Brian K. Post, Knoxville, TN (US); Orlando Rios, Knoxville, TN (US)

(21) Appl. No.: 14/953,515

(22) Filed: Nov. 30, 2015

(51) Int. Cl. B29C 67/00

(52) U.S. Cl. CPC B29C 67/0096; B33Y 10/00

(57) ABSTRACT

Several examples of additive manufacturing machines and methods for depositing a bead of composite polymer material having continuous fiber reinforcement are disclosed. A length of fiber reinforcement is provided to a nozzle. The fiber reinforcement is embedded into a stream of a base polymer material at the nozzle and deposited as a bead of composite polymer material having fiber reinforcement. The fiber reinforcement may be dry or pre-impregnated with a reinforcing polymer. The additional strength of the composite polymer material having fiber reinforcement allows for true, three-dimensional printing of articles having unsupported regions.

### CROSS-REFERENCE TO RELATED APPLICATIONS

This patent application is related to U.S. Nonprovisional patent application Ser. No. ______, entitled “An Article Made by Additive Manufacturing with Continuous Fiber Reinforcements”, filed concurrently, which is incorporated herein by reference in its entirety.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### THE NAMES OF THE PARTIES TO A JOINT RESEARCH AGREEMENT

None.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

None.

### STATEMENT REGARDING PRIOR DISCLOSURES BY THE INVENTOR OR A JOINT INVENTOR

None.

### BACKGROUND OF THE INVENTION

1. Field of the Invention

The present disclosure relates to polymer additive manufacturing and more specifically to additive manufacturing machines, methods and articles of manufacture having a continuous fiber reinforced structure for additional strength.

2. Description of the Related Art

Additive manufacturing is a technology used to efficiently manufacture three-dimensional parts layer-by-layer. Unlike subtractive technologies that require additional time and energy to remove excess material, additive manufacturing deposits material only where it is needed, making very efficient use of both energy and raw materials. Additive manufacturing may be accomplished using polymers, alloys, resins or similar feed stock materials that transition from a liquid or powder to a cured, solid component.

In order to construct features such as cantilevered beams, overhangs or arches, sacrificial supports must typically be deposited to counteract the force of gravity. Once the part is complete, the support structures are removed using various mechanical and chemical means. The creation and removal of support structures wastes material and energy and adds time to the build.

The Manufacturing Demonstration Facility (MDF) at Oak Ridge National Laboratory (ORNL) pioneered the Big Area Additive Manufacturing (BAAM) technology, which is based on extruding thermoplastic pellets through a screw extruder in large-scale layers. Recent efforts have demonstrated that discontinuous or chopped fiber reinforced feed stock increases the strength and stiffness of the final part and also enables “out of the oven” additive manufacturing capability. The chopped fibers significantly increase the thermal conductivity and reduce the coefficient of thermal expansion of the material. This allows extremely large parts to be built at room temperature and with significantly less distortion than non-reinforced materials.

While building parts of discontinuous fiber reinforced feed stock provides significant advantages in terms of room temperature processing and dimensional stability, the discontinuous fibers are limited in terms of strength and still require a sacrificial structure for supporting cantilevered or arched features. Improvements to additive manufacturing machinery and materials are needed to advance the technology beyond the current state of the art.

### BRIEF SUMMARY OF THE INVENTION

Disclosed are several examples of additive manufacturing machines, methods and articles of manufacture.

The following summary is provided to facilitate an understanding of some of the innovative features unique to the embodiments and is not intended to be a full description. A full appreciation of the various aspects of the embodiments disclosed can be gained by taking the entire specification, drawings, claims and abstract as a whole.

According to one aspect, an additive manufacturing machine for depositing a bead of polymer material with embedded continuous fiber reinforcement comprises: a) a material delivery system for delivering a polymer material to a nozzle; b) a drive device for delivering a length of continuous fiber reinforcement to the nozzle; and, c) where the nozzle is configured to embed the continuous fiber reinforcement into the base polymer material and simultaneously deposit the base polymer material and the continuous fiber reinforcement as a bead of composite polymer material.

According to another aspect, a method for building a composite article with an additive manufacturing machine comprises the steps of: a) providing a length of continuous fiber reinforcement to a nozzle of the additive manufacturing machine; b) embedding the continuous fiber reinforcement into a stream of a base polymer material at the nozzle; and, c) depositing the continuous fiber reinforcement and the base polymer material simultaneously with the nozzle as a bead of composite polymer material in at least a portion of the composite article.

According to another aspect, a composite article of manufacture comprises: a) one or more extruded beads of a polymer material; and, b) where at least one of the one or more extruded beads of polymer material includes embedded continuous fiber reinforcement.

### BRIEF DESCRIPTION OF THE SEVERAL VIEWS OF THE DRAWING(S).

The machines, methods and articles may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a side view of an exemplary segment of continuous fiber reinforcement.

FIG. 2 is a cross section view of the segment of continuous fiber reinforcement of FIG. 1 taken in the direction of line 2-2.

FIG. 3 is a side view of another exemplary segment of continuous fiber reinforcement.

FIG. 4 is a cross sectional view of the segment of continuous fiber reinforcement of FIG. 3 taken in the direction of line 4-4.

FIG. 5 is a cross sectional schematic of an exemplary segment of, continuous fiber reinforcement that is pre-impregnated with a polymer.

FIG. 6 is a cross sectional schematic of the segment of the continuous fiber reinforcement of FIG. 5 when viewed in the direction of line 6-6.

FIG. 7 is an example of an additive manufacturing nozzle assembly for depositing a polymer material having continuous fiber reinforcement.

FIG. 8 is another example of an additive manufacturing nozzle assembly for depositing a polymer material having continuous fiber reinforcement.

FIG. 9 is another example of an additive manufacturing nozzle assembly for depositing a polymer material having continuous fiber reinforcement.

FIG. 10 is another example of an additive manufacturing nozzle assembly for depositing a polymer material having continuous fiber reinforcement.

FIG. 11 is another example of an additive manufacturing nozzle assembly for depositing a polymer material having continuous fiber reinforcement.

FIG. 12 is another example of an additive manufacturing nozzle assembly for depositing a polymer material having continuous fiber reinforcement.

FIG. 13 is a schematic representation of a series of method steps for making a composite article of manufacture using additive manufacturing with polymer materials having continuous fiber reinforcement.

FIG. 14 is a schematic sectional representation of a composite article of manufacture that is manufactured using the disclosed additive manufacturing machines and methods.

### DETAILED DESCRIPTION OF THE INVENTION

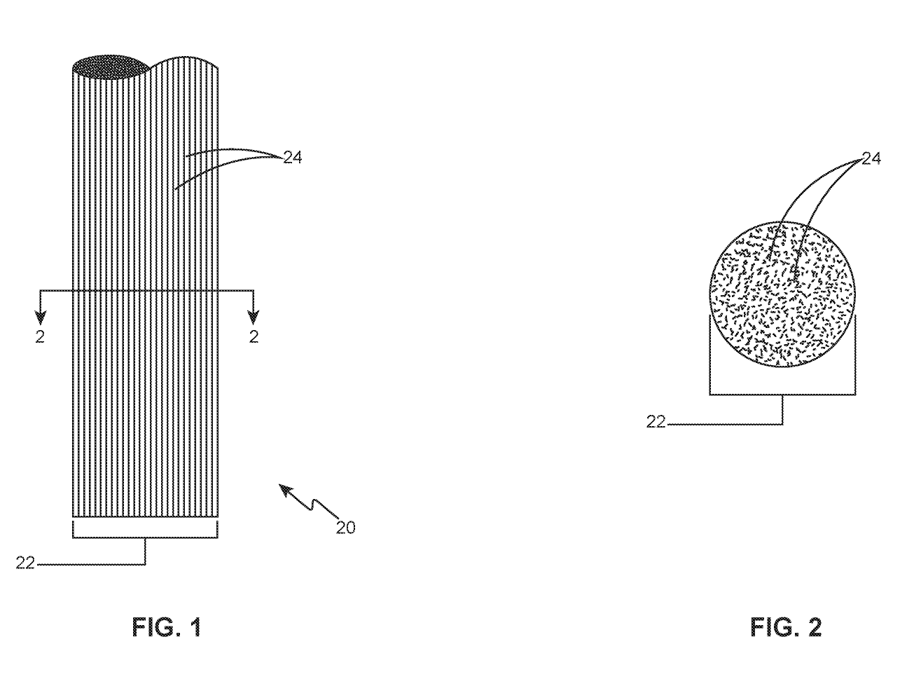

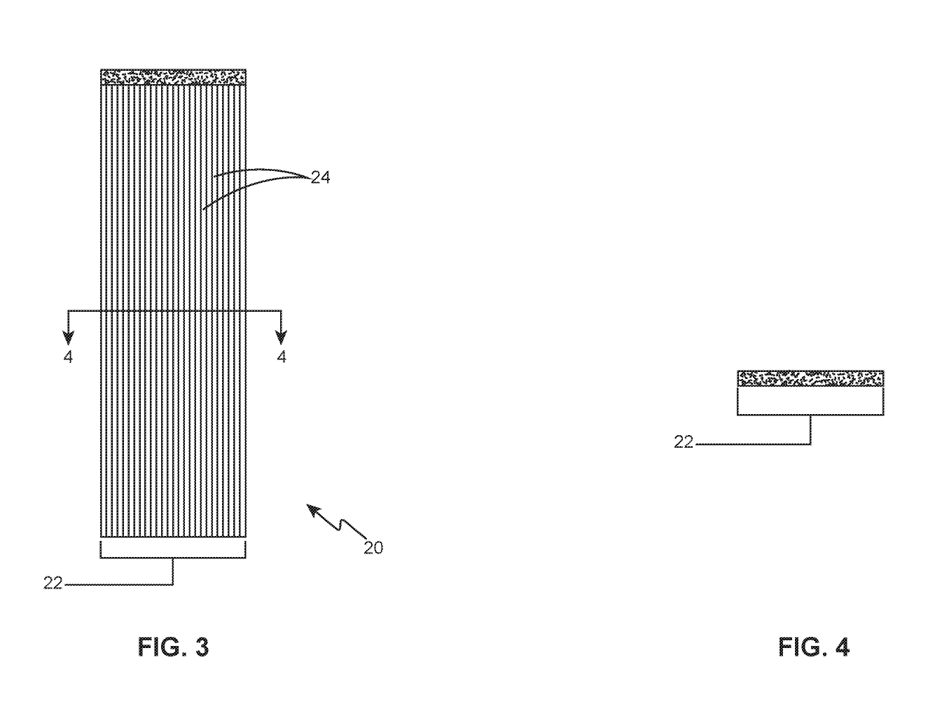

With reference first to FIGS. 1-4, two examples of dry continuous fiber reinforcements 20 will now be described in detail. The terms “continuous fiber reinforcements” encompass fiber reinforcements that are uncut, which provide a considerable strength advantage over chopped fibers. In these examples, a tow 22 or bundle of unidirectional (shown), multidirectional or woven filaments 24 may be round-shaped (FIGS. 1-2), ribbon-shaped (FIGS. 3-4), or otherwise shaped. The individual filaments 24 may be made from carbon, glass, aramid or other materials having diameters of approximately 5 to 10 micrometers. Depending on the size and strength requirements of the final part, filament 24 counts can be approximately 2,000-50,000, although lower or higher counts may also be used. These examples illustrate dry tows 22, since no additional material is present in the continuous fiber reinforcements 20.

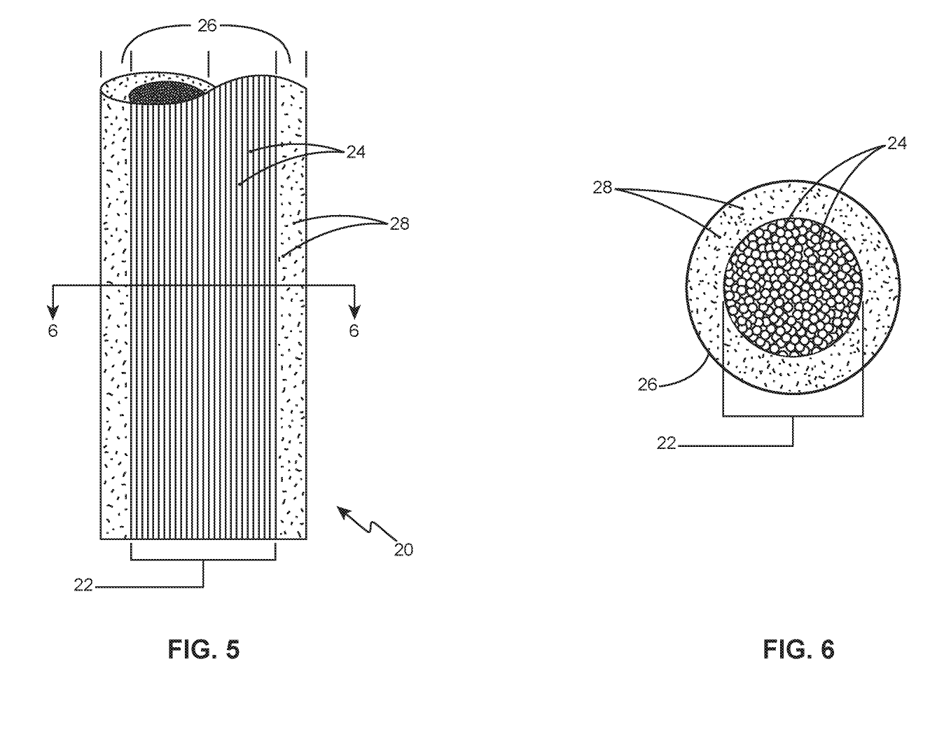

Referring now to FIGS. 5-6, an example of continuous fiber reinforcement 20 that is impregnated with a reinforcing polymer material 26 is illustrated. In this example, the continuous fiber reinforcement 20 includes a tow 22 that has been pre-impregnated, within and/or around the filaments 24, with a reinforcing polymer material 26. While it is difficult to illustrate reinforcing polymer 26 present within and between the individual filaments 24 in the drawings, that feature is intended by this disclosure. The tow 22 can be approximately 10% to 60% of the total volume of the pre-impregnated continuous fiber reinforcement 20, although lower or higher fill rates may be used. The reinforcing polymer material 26 may be chosen from a thermoplastic polymer, a combination of thermoplastic polymers, a thermoset polymer, a combination of thermoset polymers and a combination of thermoplastic and thermoset polymers.

Thermoplastic polymers soften when heated and will flow when heated to above the glass transition temperature and typically above the melting temperature. The material flow is driven by a combination of heat and pressure. The fluid stream can be deposited and cooled to form a solid bead of polymer. The solidification process is mostly reversible as no chemical bonding takes place, which allows most thermoplastic polymer materials to be recycled.

Exemplary thermoplastic materials are: ABS, Polycarbonate, PLA, ULTEM™ brand Resin, Polyetherimide (PEI), NYLON and PPSE/PPSU for example. Other suitable materials are described in U.S. Nonprovisional Patent Application Ser. No. 14/143,989, entitled “Room Temperature Polymer Additive Manufacturing”, filed 30-Dec.-2013. These thermoplastic polymer examples may be combined together or combined with thermoset polymers.

A thermosetting polymer, also known as a thermoset, is a prepolymer material that cures irreversibly. The cure may be induced by heat, generally above 200° C. (392° F.), through a chemical reaction, or suitable irradiation such a UV light for example. Thermoset polymers are able to chemically cross-link together during the solidification process to form an irreversible chemical bond. The cross-linking process forms a molecule with a larger molecular weight, resulting in a material with a higher melting point. During the reaction, the molecular weight increases to a point so that the melting point is higher than the surrounding ambient temperature, the material forms into a solid material. The cross-linking bond limits remelting when heat is applied, thus making thermosets ideal for high-heat applications.

Exemplary thermoset materials are: Bis-Maleimid (BMI), Epoxy (Epoxide), Phenolic (PF), Polyester (UP), Polyimide, Polyurethane (PUR) and Silicone for example. Other suitable materials are described in U.S. Provisional Patent Application Ser. No. 62/180,181, entitled “Thermoset Composite Having Thermoplastic Characteristics”, filed 16-Jun.-2015, and U.S. Provisional Patent Application Ser. No. 62/143,691, entitled “3D Printable Liquid Crystalline elastomers with tunable shape memory behaviors and bio-derived renditions”, filed 6-Apr.-2015, and U.S. Provisional Patent Application Ser. No. 62/158,588, entitled “3D Printing of Polyureas”, filed 8-May-2015. These thermoset polymers may be combined together or combined with thermoplastic polymers.

The preceding examples of thermoplastic and thermoset polymer materials are not exhaustive and other polymer materials known today, or that may be developed in the future, may also be suitable.

In some examples, the reinforcing polymer material 26 may contain chopped reinforcing fibers 28 made from carbon, glass, aramid or other materials. In some examples, the chopped reinforcing fibers 28 are coated with an electro-magnetically susceptible nickel coating and are heated when introduced to an electro-magnetic field. The addition of chopped fibers is fully described in U.S. Nonprovisional patent application Ser. No. 14/143,989, entitled “Room Temperature Polymer Additive Manufacturing”, filed 30-Dec.-2013.

The process for making the pre-impregnated fiber reinforcements 20 is similar to the process for making pultruded composite structures such as rods or tubes. In the process, a tow 22 of filaments 24 is pulled through a stream of polymer material 26 and a shaped die, which provides the final shape of the pre-impregnated fiber reinforcements 20. The polymer material 26 impregnates the filaments 24 with the polymer material remaining liquid, partially solidified or fully solidified, depending on the polymer material properties and environmental conditions (e.g. temperature, humidity, light). The pre-impregnated fiber reinforcements 20 may be wound onto spools and cut to length by a cutting means or produced continuously insitu. Exemplary fiber reinforcements 20 that are pre-impregnated with thermoset polymers may be purchased from TCR Composites, 219 North 530 West, Ogden, Utah 84404 for example. Exemplary fiber reinforcements 20 that are pre-impregnated with thermoplastic polymers may be purchased from PlastiComp, Inc., 110 Galewski Dr, Winona, Minn. 55987 for example.

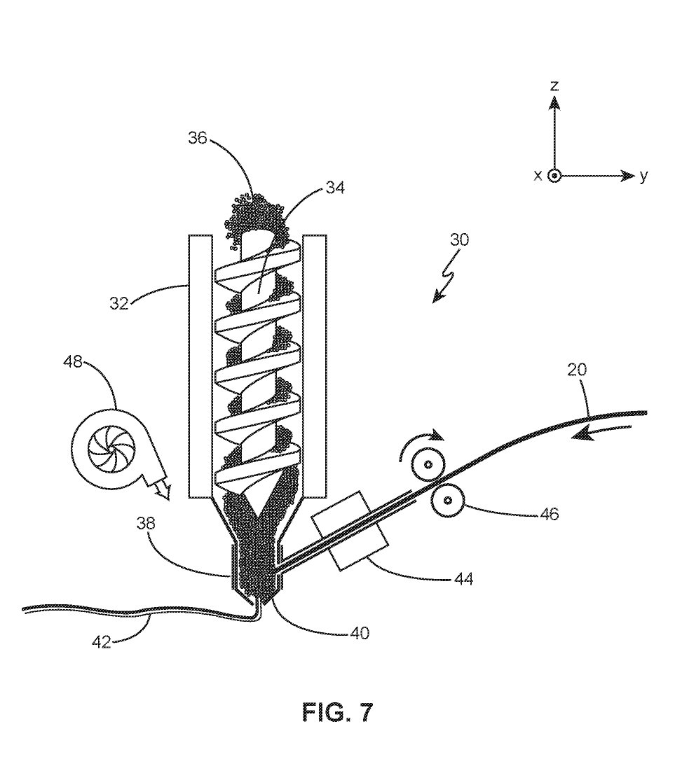

With reference now to FIG. 7, an exemplary additive manufacturing nozzle assembly 30 for depositing a bead of polymer material having continuous fiber reinforcements 42 is illustrated. The nozzle assembly 30 has a central axis and deposits material within, or outside of, the X-Y plane. With fiber reinforcements 20, true, three-dimensional printing is possible without the need for a support structure. In this example, an extruder barrel 32 contains a rotatable screw 34, which conveys a base polymer material 36 in pellet, granular, beads or other form through a heater 38 (e.g., electrical resistance heater, induction heater, etc . . . ) to a nozzle 40. In these examples, a single or multiple screw extruder may be used. The base polymer material 36 may be chosen from a thermoplastic polymer, a combination of thermoplastic polymers, a thermoset polymer, a combination of thermoset polymers and a combination of thermoplastic and thermoset polymers as described above with respect to the reinforcing polymer material 26. In some examples, the base polymer material 36 may contain chopped reinforcing fibers as described above.

A length of continuous fiber reinforcement 20 is embedded into a stream of base polymer material 36 at the nozzle 40 and simultaneously deposited as a bead of composite polymer material having embedded continuous fiber reinforcement 42. The fiber reinforcement 20 enters the nozzle 40 upstream of the orifice, at the orifice or downstream of the orifice. Since the continuous fiber reinforcement 20 may be relatively rigid in some examples, a preheater 44 may be used to raise the temperature of, and soften, the fiber reinforcement 20 so that it will conform to the nozzle 40 and the part during deposition. The preheating also helps embed the fiber reinforcement 20 within the stream of base polymer material 36 at the nozzle 40. The preheating temperature is based on the glass transition temperature of the polymer materials 26 and is kept at or slightly below the glass transition temperature. A drive device 46, such as counter-rotating friction wheels, delivers the fiber reinforcement 20 at a linear speed that is synchronized with the nozzle assembly's 30 linear speed. A temperature control device 48 may be used to heat or cool the deposited bead 42 to control solidification and cross linking and to aid the out-of-plane deposition.

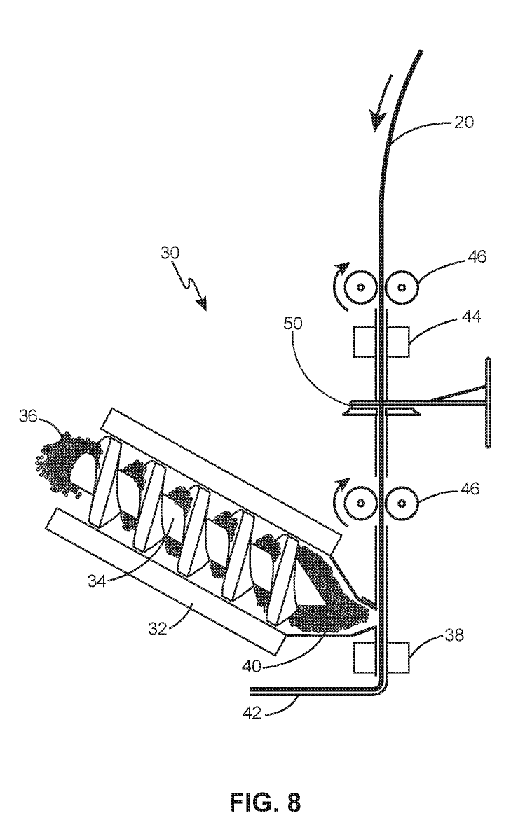

With reference now to FIG. 8, another exemplary additive manufacturing nozzle assembly 30 for depositing a bead of polymer material having embedded continuous fiber reinforcement 42 is illustrated. In this example, a continuous fiber reinforcement 20 is delivered by a drive device 46 through a preheater 44 before passing through cutting device 50. The preheater 44 effectively softens the fiber reinforcement 20, so that the cutting device 50 can effectively cut it to length as needed. The cutting device 50 may be a linear guillotine, a rotating blade, a laser, or other fiber cutting device known in the art. Cutting the fiber reinforcement 20 is often necessary when the nozzle assembly 30 must be repositioned or when transitioning to areas of the part where reinforcement with continuous fibers is not necessary.

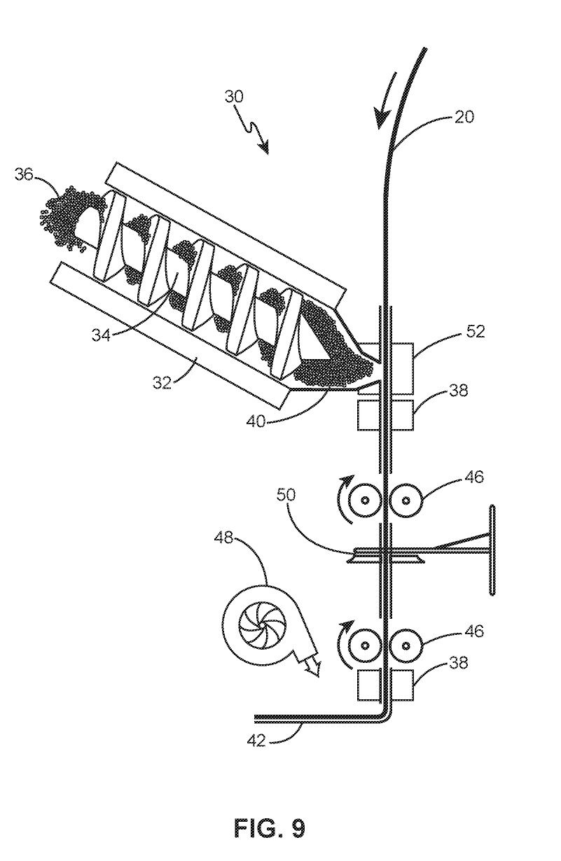

With reference now to FIG. 9, another exemplary additive manufacturing nozzle assembly 30 for depositing a bead of polymer material having embedded continuous fiber reinforcement 42 is illustrated. In this example, a continuous fiber reinforcement 20 is delivered by drive devices 46 through a die 52, which is supplied with a stream of base polymer 36 from a nozzle 40. A cutting device 50 cuts the continuous fiber reinforcement 20 to length as described above. Finally, a bead of polymer material with embedded continuous fiber reinforcement 42 is deposited. In this example, the continuous fiber reinforcement 20 is dry before it reaches the die 52.

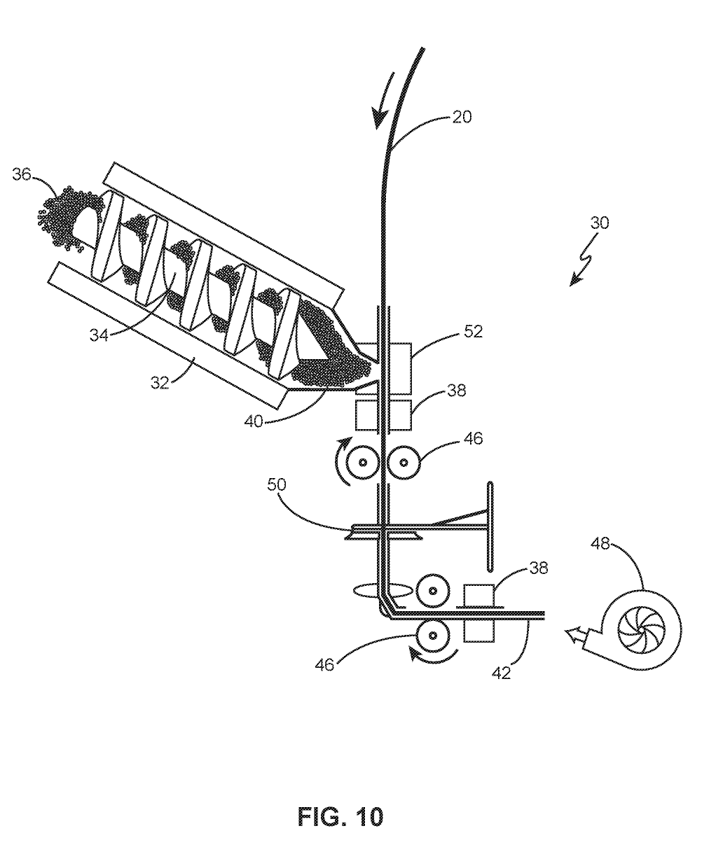

With reference now to FIG. 10, another exemplary additive manufacturing nozzle assembly 30 for depositing a a bead of polymer material having embedded continuous fiber reinforcement 42 is illustrated. In this example, the bead of polymer material with embedded continuous fiber reinforcement 42 is deposited out of the X-Y plane.

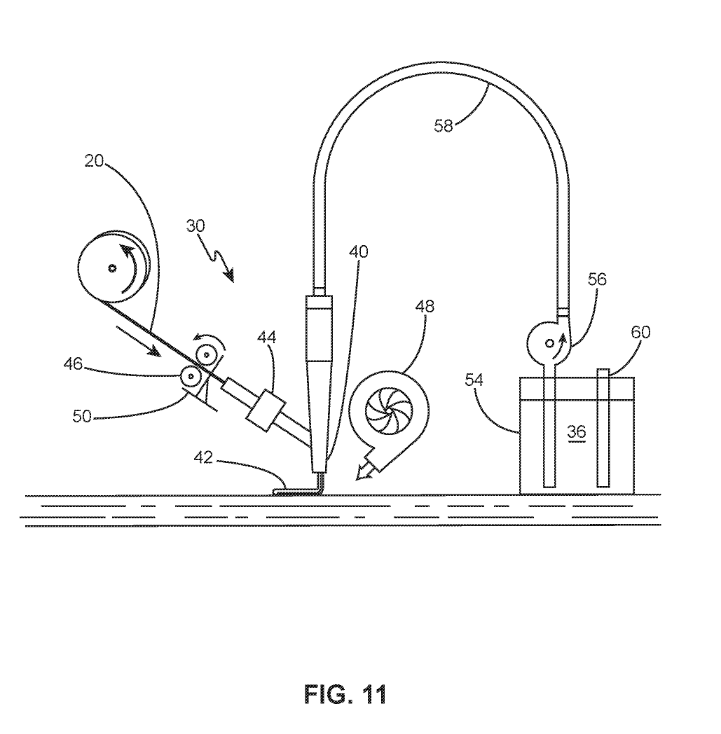

With reference now to FIG. 11, another exemplary additive manufacturing nozzle assembly 30 for depositing a bead of polymer material having embedded continuous fiber reinforcement 42 is illustrated. In this example, the base polymer material 36 is stored in a tank 54 and pumped via a pump 56, through a transfer line 58, to the nozzle 40. At the nozzle 40, the continuous fiber reinforcement 20 is embedded into the base polymer material 36 and a cutting device 50 cuts it to length as needed. In some examples, a submerged heater 60 maintains the base polymer material 36 within a specified range of temperatures.

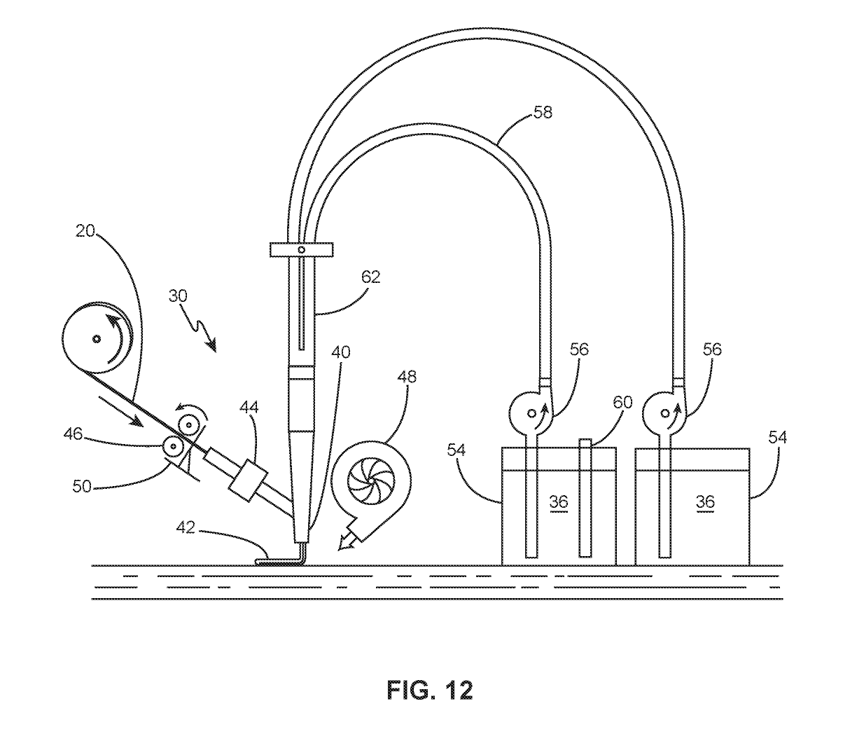

With reference now to FIG. 12, another exemplary additive manufacturing nozzle assembly 30 for depositing a bead of polymer material having embedded continuous fiber reinforcement 42 is illustrated. In this example, the base polymer material 36 is stored in two tanks 54 and pumped via separate transfer lines 58, to a manifold 62. At the manifold 62, the materials mix before the continuous fiber reinforcement 20 is embedded at the nozzle 40. In some examples, the base polymer material 36 is a one-part polymer material. In some examples, the base polymer material 36 is a two-part polymer material. In other examples, the base polymer material 36 is two different polymer materials.

While each of the previous examples illustrates a single fiber reinforcement 20 being embedded into a stream of polymer 36 at a nozzle 40, other examples embed two or more of the same or different fiber reinforcements 20. For example, a first fiber reinforcement 20 may comprise carbon filaments 24 and a second fiber reinforcement 20 may comprise glass filaments 24. The two fiber reinforcements 20 may be embedded simultaneously or in series based on strength requirements of the feature or part being built.

Note that in each example described above, process parameters such as: nozzle assembly 30 linear speed and direction; base polymer material 36 flow rate; heater 38 temperature; preheater 44 temperature; drive device 46 speed; temperature control device 48 temperature; cutting device 50 function; die 52 temperature; pump 56 speed; heater 60 temperature; for example, are controlled by a central computing device. Distributed sensors provide feedback to the computing device so that parameters can be adjusted to synchronize and optimize the process.

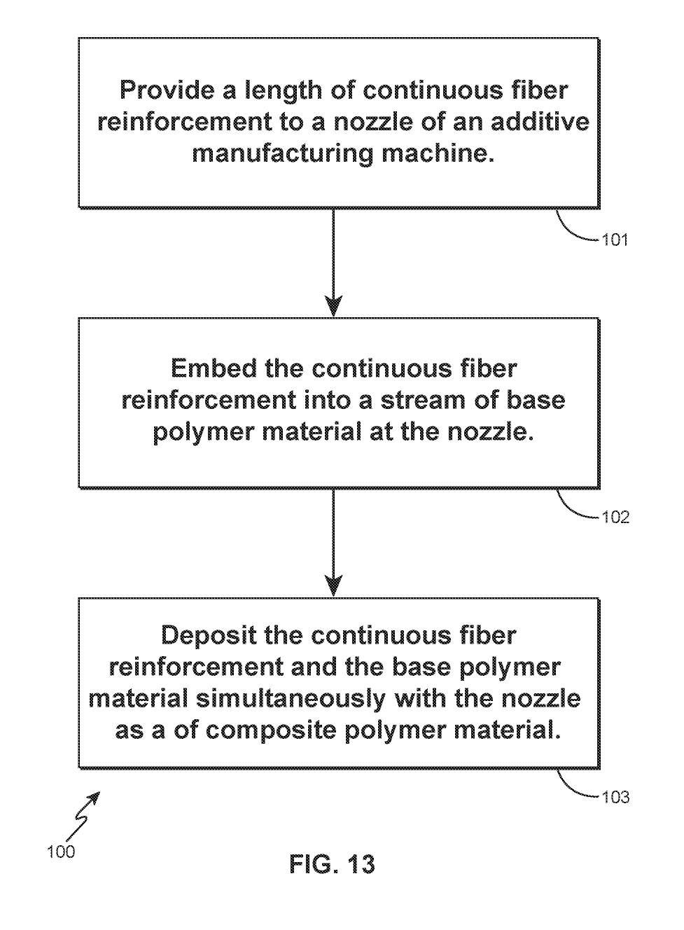

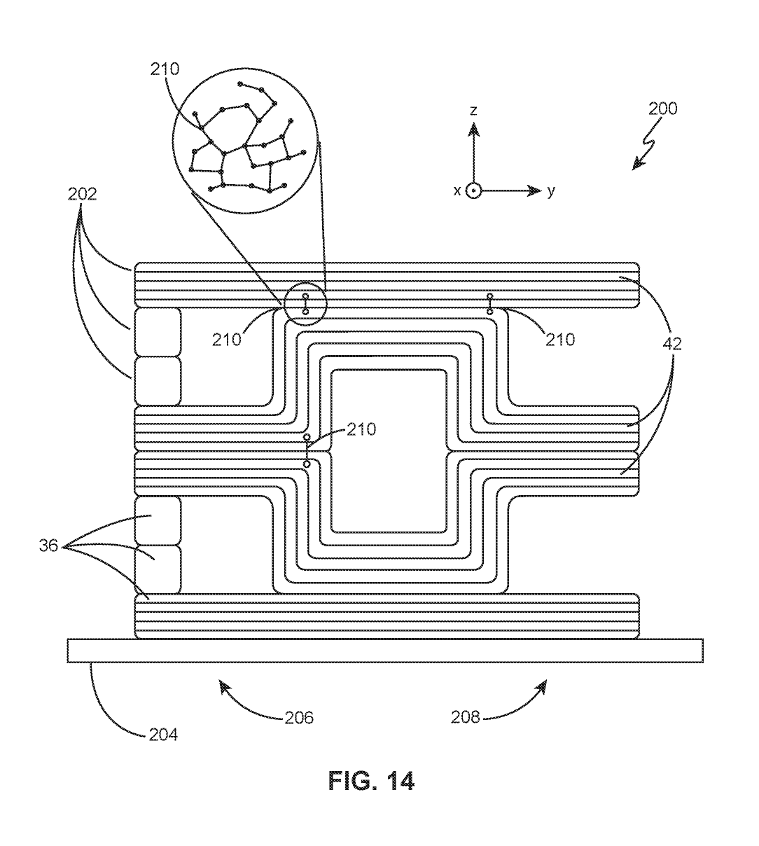

A method 100 for producing a continuous fiber reinforced composite article with an additive manufacturing machine is schematically illustrated in FIG. 13. In step 101, a length of continuous fiber reinforcement 20 is provided to a nozzle 40 of an additive manufacturing machine. In step 102, the continuous fiber reinforcement 20 is embedded into a stream of base polymer material 36 at the nozzle 40. In some examples, the fiber reinforcement 20 is heated with a preheater 44 before embedding. In some examples, two or more fiber reinforcements 20 are embedded simultaneously or serially. In some examples, the fiber reinforcement 20 is pre-impregnated with a reinforcing polymer material 26 prior to embedding. In some examples, the base polymer 36 and reinforcing polymer 26 are the same polymer material and in other examples, they are different materials. In step 103, the nozzle 40 deposits the continuous fiber reinforcement and the base polymer material simultaneously with the nozzle as a bead of polymer material having embedded continuous fiber reinforcement 42 in at least a portion of the composite article. Advantageously, composite articles having unsupported regions or features are now possible to build without the need for time-consuming and costly support structures.

FIG. 14 illustrates an exemplary part, build or composite article of manufacture 200 that is manufactured using the disclosed machines and methods. The exemplary article 200 is built in one or more layers 202 on a build platform 204 that typically extends in the X-Y plane of a build volume as illustrated by the reference axes. In one example, at least a portion of a layer 202 includes a composite bead of polymer material with embedded continuous fiber reinforcement 42. In another example, two adjacent beads 42 include cross-links, schematically illustrated as 210. The adjacent beads 42 may be in the same layer 202 or in consecutive layers 202.

Please note that a continuous fiber reinforcement 20 may be embedded in one or more of the layers 202 and inclusion is dependent on the strength requirements of each feature of the article 200. For example, continuous fiber reinforcement may not be necessary in supported areas or regions 206, but may be necessary in unsupported areas or regions 208. Features such as steeply angled trusses, arches, cantilevered beams, flanges and holes for example can now be built in the absence of supporting structures, saving time, energy and material.

While this disclosure describes and enables several examples of additive manufacturing machines, methods and articles of manufacture, other examples and applications are contemplated. Accordingly, the invention is intended to embrace those alternatives, modifications, equivalents, and variations as fall within the broad scope of the appended claims. The technology disclosed and claimed herein may be available for licensing in specific fields of use by the assignee of record.

What is claimed is:

1. A method for manufacturing a composite article with an additive manufacturing machine comprising the steps of:
a) providing a continuous fiber reinforcement;
b) embedding the continuous fiber reinforcement into a stream of a base polymer material at a nozzle of the additive manufacturing machine;
c) depositing the continuous fiber reinforcement and the base polymer material simultaneously with the nozzle as a bead of composite polymer material having embedded continuous fiber reinforcement in at least a portion of the composite article.

2. The method of claim 1 wherein the embedding step b) further includes advancing the continuous fiber reinforcement with a drive device.

3. The method of claim 1 wherein the embedding step b) further includes cutting the continuous fiber reinforcement at a point on its length with a cutting device.

4. The method of claim 1 and further comprising the step of:
d) changing the temperature of the bead of composite polymer material having embedded continuous fiber reinforcement with a temperature controlling device.

5. The method of claim 1 wherein the depositing step c) is performed over an unsupported region of the composite article.

6. The method of claim 1 wherein the filaments in the continuous fiber reinforcement are selected from the group of materials consisting of carbon, glass, and aramid.

7. The method of claim 1 wherein the base polymer material is selected from the group consisting of a thermoplastic polymer, a combination of thermoplastic polymers, a thermoset polymer, a combination of thermoset polymers and a combination of thermoplastic and thermoset polymers.

8. The method of claim 1 wherein the polymer material includes discontinuous fibers that are distributed in the material and are selected from the group of materials consisting of carbon, glass, and aramid.

9. A method for manufacturing a composite article with an additive manufacturing machine comprising the steps of:
a) providing a continuous fiber reinforcement that is pre-impregnated with a reinforcing polymer material;
b) embedding the pre-impregnated continuous fiber reinforcement into a stream of a base polymer material at a nozzle of the additive manufacturing machine;
c) depositing the pre-impregnated continuous fiber reinforcement and the polymer material simultaneously with the nozzle as a bead of composite polymer material having embedded continuous fiber reinforcement in at least a portion of the composite article.

10. The method of claim 9 wherein the embedding step b) further includes advancing the pre-impregnated continuous fiber reinforcement with a drive device.

11. The method of claim 9 wherein the embedding step b) further includes cutting the pre-impregnated continuous fiber reinforcement at a point on its length with a cutting device.

12. The method of claim 9 wherein the embedding step b) further includes preheating the pre-impregnated continuous fiber reinforcement with a heating device.

13. The method of claim 9 and further comprising the step of:
d) changing the temperature of the bead of composite polymer material having embedded continuous fiber reinforcement with a temperature controlling device.

14. The method of claim 9 wherein the depositing step c) is performed over an unsupported region of the composite article.

15. The method of claim 9 wherein the filaments in the continuous fiber reinforcement are selected from the group of materials consisting of carbon, glass, and aramid.

16. The method of claim 9 wherein the polymer materials are the same polymer material.

17. The method of claim 9 wherein each one of the polymer materials is selected from the group consisting of a thermoplastic polymer, a combination of thermoplastic polymers, a thermoset polymer, a combination of thermoset polymers and a combination of thermoplastic and thermoset polymers.

18. The method of claim 9 wherein at least one of the polymer materials includes distributed, discontinuous fibers that are selected from the group of materials consisting of carbon, glass, and aramid.

19. An additive manufacturing machine for depositing a bead of polymer material having embedded continuous fiber reinforcement, the machine comprising:
a material delivery system for delivering a base polymer material to a nozzle;
a drive device for delivering a continuous fiber reinforcement to said nozzle; and,
wherein said nozzle is configured to embed the continuous fiber reinforcement into the base polymer material and simultaneously deposit the base polymer material and the continuous fiber reinforcement as a bead of composite polymer material having embedded continuous fiber reinforcement.

20. The additive manufacturing machine of claim 19 and further comprising a preheater for heating the continuous fiber reinforcement before it is embedded into the base polymer material.

21. The additive manufacturing machine of claim 19 and further comprising a cutting device for cutting the continuous fiber reinforcement.

22. The additive manufacturing machine of claim 19 and further comprising a temperature controlling device for changing the temperature of the bead of composite polymer material having embedded continuous fiber reinforcement.

23. The additive manufacturing machine of claim 19 wherein the nozzle deposits the bead of composite polymer material having embedded continuous fiber reinforcement in an unsupported region.

24. The additive manufacturing machine of claim 19 wherein the material delivery system is a single or a multiple screw extruder.

25. The additive manufacturing machine of claim 19 wherein the material delivery system is a pump.
